(19) United States
(12) Patent Application Publication
(10) Pub. No.: US 2011/0231261 A1
(43) Pub. Date: Sep. 22, 2011

(54) VOICE CUSTOMIZATION FOR VOICE-ENABLED TEXT ADVERTISEMENTS

(75) Inventors: PRAVEEN CHAKRAVARTHY SATTARU, BELLEVUE, WA (US); TCHAVDAR DANGALTCHEV, BELLEVUE, WA (US)

(73) Assignee: MICROSOFT CORPORATION, REDMOND, WA (US)

(21) Appl. No.: 12/726,035

(22) Filed: Mar. 17, 2010

(51) Int. Cl. G06Q 30/00; G06F 17/30

(52) U.S. Cl. 705/14.66; 705/14.72; 707/776; 707/E17.108; 707/E17.101

(57) ABSTRACT

Methods are provided for determining a customized voice to be used for an audio advertisement. Text of an advertisement is received, and it is determined that audio is to be generated from the text of the advertisement, and that the audio is to comprise a customized voice. The customized voice is selected by the advertiser. The audio is generated from the text of the advertisement, and the text, audio, and indications that the advertisement is voice-enabled and that a customized voice is to be used in association with the audio are stored in an advertisement storage. When a request is received for advertisements, at least one advertisement is communicated for presentation to the user, such that the text is visually presented to the user and audio comprising the customized voice is audibly presented to the user.

### CROSS-REFERENCE TO RELATED APPLICATIONS

This application is related by subject matter to the invention disclosed in the following U.S. patent applications filed on even date herewith: U.S. application Ser. No. (not yet assigned) (Attorney Docket Number MFCP.153774), entitled “PRICING FOR VOICE-ENABLED TEXT ADVERTISEMENTS;” and U.S. application Ser. No. (not yet assigned) (Attorney Docket Number MFCP.153773), entitled “VOICE-ENABLED TEXT ADVERTISEMENTS;” each of which is assigned or under obligation of assignment to the same entity as this application, and incorporated in this application by reference.

### BACKGROUND

Online advertising has become a significant aspect of computing environments, as it presents a powerful way for advertisers to market their products and services. For instance, online advertising is often more likely to allow advertisers to effectively deliver advertisements to their target audiences as compared with traditional media advertising, such as newspapers, magazines, and radio. Additionally, there are a variety of advertisement systems and methods for delivering online advertisements for presentation to users. Generally, online advertising includes any form of advertising that uses computer network environments to deliver advertisements and other marketing messages to potential customers. For instance, advertisements may be presented within web pages, search engine search results, online video games, advertisement-based software applications, and email messages, to name a few. A wide variety of additional approaches and environments exist for delivering online advertising for presentation to users.

Currently, electronic advertisements may range from simple text-based advertisements to rich media advertisements, which are capable of numerous features including playing sound and/or video, expanding, and animation. Generally, advertisers may employ rich media advertisements to include functions to engage with users in an attempt to increase the likelihood that users will notice the advertisements and ultimately purchase the advertisers' goods or services. However, rich media advertisements require substantial effort and investment by advertisers to create the advertisements as compared to simple text-based advertisements. Additionally, some environments in which advertisements are presented may not be suitable for rich media advertisements.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to providing voice-enabled text advertisements for presentation in electronic advertising environments. When an advertiser submits an advertisement, which includes text, to an advertisement delivery system, the advertiser indicates whether the advertisement is to be voice-enabled. In addition, an indication is received as to whether audio associated with the advertisement is to comprise a customized voice. In one embodiment, the advertiser selects a customized voice. In another embodiment, the customized voice is algorithmically determined based on one or more of the content of the advertisement of information associated with the user, such as information in a user profile. In one instance, a user-preferred customized voice overrides other determined customized voices, such as the customized voice selected by the advertiser. The advertisement delivery system stores advertisements with an indication of whether each advertisement is voice-enabled, and whether voice customization is to be employed. When a request is received for an advertisement, both the text and audio generated from the text of the advertisement are communicated for presentation to the user.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system in which embodiments of the invention may be employed;

FIG. 3 is a block diagram of an exemplary advertisement delivery system in accordance with an embodiment of the present invention;

FIG. 4 is a flow diagram showing a method for creating and storing an advertisement in accordance with an embodiment of the present invention;

FIG. 5 is a flow diagram showing a method for selecting and delivering a voice-enabled text advertisement in accordance with an embodiment of the present invention;

FIG. 6 is an illustrative screen display showing a search results page including voice-enabled text advertisements in accordance with an embodiment of the present invention;

FIG. 7 is a flow diagram showing a method for customizing a voice associated with audio of an advertisement based on an indication received by an advertiser, in accordance with an embodiment of the present invention;

FIG. 8 is a flow diagram showing a method for customizing a voice associated with audio of an advertisement based on content of the advertisement, in accordance with an embodiment of the present invention;

FIG. 9 is a flow diagram showing a method for customizing a voice associated with audio of an advertisement based on user preferences, in accordance with an embodiment of the present invention;

FIG. 10 is a flow diagram showing a method for selecting a voice-enabled text advertisement in accordance with an embodiment of the present invention;

FIG. 11 is a flow diagram showing a method for allocating a cost for a voice-enabled text advertisement to an advertiser in accordance with an embodiment of the present invention; and

FIG. 12 is a flow diagram showing a method for calculating a price estimation in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide voice-enabled text advertisements for presentation to users. In accordance with embodiments of the present invention, an advertiser may submit an advertisement to an advertisement delivery system that facilitates delivery of advertisements within electronic environments. The electronic environments in which advertisements may be delivered include, for instance, search results, web pages, online games, advertisement-supported software applications, and emails. The advertisement submitted by the advertiser generally includes text without an audio corresponding to the text. In some embodiments, the advertisement submitted by the advertiser is a text-only advertisement that includes only text without any rich media. In other embodiments, the advertisement submitted by the advertiser may be a rich media advertisement that includes text but does not include audio of the text. As used herein, the term “text advertisement” generally refers to an advertisement that includes text without audio corresponding to the text.

When the advertiser submits a text advertisement, the advertiser may submit additional information for the advertisement and/or select from a variety of options. In accordance with embodiments of the present invention, the advertiser may specify whether the submitted text advertisement is to be voice-enabled. In particular, the advertiser specifies whether the advertisement delivery system is to create audio that comprises voice corresponding with the text of the advertisement. If the advertiser specifies that a text advertisement is to be voice-enabled, the advertisement delivery system stores the advertisement with an indication that the advertisement is voice-enabled. Accordingly, as used herein, the term “voice-enabled text advertisement” refers to a text advertisement submitted to an advertisement delivery system by an advertiser for which the advertiser has instructed the advertisement delivery system to generate a voice audio for the text of the advertisement and to provide the voice audio with the text advertisement being delivered to a user. As such, advertisers may simply provide text of advertisements to an advertisement delivery system without having to also generate and provide corresponding audio. Instead, the advertisement delivery system may generate voice audio for text advertisements that advertisers specify as being voice-enabled.

When the advertisement delivery system receives a request for advertisements, one or more advertisements are selected for delivery. The advertisement delivery system determines whether any of the advertisements are voice-enabled and accesses a voice audio for any voice-enabled text advertisements. In some embodiments, voice audio is generated for a selected voice-enabled text advertisement based on the text of the advertisement after the voice-enabled text advertisement has been selected for delivery. In other embodiments, voice audio for a selected voice-enabled text advertisement may have been previously created and stored in association with the advertisement. For instance, the advertisement delivery system may have generated and stored voice audio for an advertisement after receiving the advertisement from the advertiser or may have previously generated and stored voice audio in response to a previous request for advertisements. In such embodiments, the stored voice audio may be retrieved for a selected voice-enabled text advertisement. To generate voice audio for the text of a voice-enabled text advertisement, the advertisement delivery system may include a text-to-voice component (or an API to such a component) that includes text-to-speech capabilities.

When voice-enabled text advertisements are delivered to a user, both the visual component of the advertisement and the voice audio are provided to the user. The visual component, including the text of the advertisement, is displayed to the user. Additionally, the voice audio is audibly presented such that the user hears the voice corresponding with the displayed text of the advertisement.

According to further embodiments of the present invention, the voice audio associated with an advertisement may be customized. Customization of a voice may be determined by the advertiser that has submitted the advertisement. For instance, at the time that an advertisement is submitted, other types of information associated with the advertisement may also be submitted, such as whether the advertisement is voice-enabled, as described above, and whether the voice audio is to be customized. If the voice audio is to be customized, the advertiser, in one instance, may even indicate a particular voice preference for the audio. This indication may be made on a user interface provided for advertisers. For example, a drop-down list may provide a plurality of voice types from which an advertiser may select. Customized voices may include a variety of voices. For example only and not limitation, customized voices may include a female's voice, a male's voice, a child's voice, a senior citizen's voice, a robot-sounding voice, an alien-sounding voice, etc. These customized voices are only examples and are not intended to limit the scope of embodiments of the present invention.

A customized voice, if desired by an advertiser, may be determined in many ways. In one embodiment, the advertiser selects the customized voice. Alternatively, the customized voice is algorithmically determined based on, for example, content of the advertisement. Data mining may be employed to extract key words from the text of an advertisement, and the advertisement delivery system may use the key words to categorize the advertisement. Categories may be predetermined and may be associated with a customized voice such that if an advertisement is associated with a particular category, the customized voice associated with that category may be selected for that advertisement. Other methods for determining customized advertisements not described herein are contemplated to be within the scope of the present invention.

As discussed, a customized voice may be determined by the advertiser or by an algorithm in the advertisement delivery system. In one embodiment, however, a user may indicate a preference for a certain voice for audible advertisements. For instance, a user profile may include user preferences that allow a user the option to select from a variety of customized voices. In one instance, the user-selected customized voice overrides the customized voice determined by either the advertiser or the algorithm in the advertisement delivery system. As such, even if a male's voice is the customized voice selected by the advertiser, if the user has indicated a preference for a female voice, a female voice is used for voice-enabled advertisement.

In yet another embodiment, a customized voice is not specified by the user in the user profile, but the customized voice is determined based on other types of information in the user profile. This determination may be made by the advertisement delivery system, for example. For instance, a user who is a male and who has indicated interests including cars and football may be more inclined to react to an advertisement if the voice is a male voice. Other types of information included in a user profile may also be taken into consideration when determining the customized voice. In one instance, this customized voice determined based on information in the user profile overrides any other determined customized voice. But, in another instance, it does not override other customized voices. It may be the case in some embodiments that the advertiser prefers that the user information be the only factor on which the determination of the customized voice is based. As such, this customized voice determined by information in the user profile does not necessarily override other customized voices, but is used as the preferred customized voice for advertisements audibly presented to a certain user. In one case, the selection of the customized voice is based on both user information and content associated with the advertisement.

As previously mentioned, when the advertisement delivery system receives a request for an advertisement, one or more advertisements are selected for delivery. Advertisements may be selected for delivery based on, for instance, expected revenue associated with the presentation of a particular advertisement, i.e., a monetization value. For instance, advertising system providers receive revenue through advertisements displayed in conjunction with, for instance, a user's search query results. The advertising system providers receive payment from advertisers based on various pay-per-impression and/or pay-per-performance models (e.g., cost-per-click or cost-per-conversion models) such that an advertising system provider may receive payment from an advertiser when an advertisement is presented and/or when a user clicks on the advertiser's advertisement, when the user performs some action after clicking the advertisement (e.g., the user purchases the product associated with the advertisement), or the like.

When submitting advertisements or otherwise managing advertising campaigns, the advertisers are permitted to “bid” on various factors associated with their advertisements and the bids may contribute to determining which advertisements will be selected for a given request for advertisements. Typically, bids are made on a cost-per-impression (CPI) or cost-per-click (CPC) basis. That is, the advertiser bids a monetary amount it is willing to pay each time an advertisement is displayed or each time a user selects or clicks on a displayed advertisement.

Advertising system providers may rank advertisements by a CPI bid and/or a CPC bid to determine which advertisements should be selected for a given request for advertisements and/or which advertisement should be displayed as a primary advertisement. For instance, Airline A may bid $1.00 for each user that accesses its information as a result of its advertisement being selected and presented while Airline B may bid $1.75 for each user that accesses its information upon its advertisement being selected and presented. In this instance, Airline B would “win” the bid and, accordingly, its advertisement may be selected to be presented. Further, Airline B's advertisement may be selected to be displayed as the primary advertisement and be placed in a prominent position. For instance, in the context of search, Airline B's advertisement may be placed a location at the top and center of the search results page or at the top of a list of advertisements. Advertisements with higher CPC bids may be placed in more prominent positions since a more prominent advertisement, or primary advertisement, has a higher likelihood of being selected by a user, thus, increasing the amount of revenue generated from CPC bids.

Alternatively, an advertisement delivery system may rank the advertisements according to a monetization value associated with the advertisements. Monetization values for text advertisements may be calculated based on both a CPC bid and a click-through rate (CTR) associated with the advertisement. CTR's are the rate at which users have clicked on a particular advertisement when presented. The product of the CPC bid and the CTR (CPC bid×CTR) is the monetization value and the highest product, i.e., the highest monetization value, may be ranked higher than other advertisements and, in turn, may be more likely to be selected for presentation. For instance, if Airline B's advertisement has a CTR of 5% then the monetization value of the advertisement may be calculated to be 0.0875 (1.75*0.05). If Airline A's advertisement has a CTR of 10% then the monetization value of the advertisement may be calculated to be 0.10 (1.00*0.10). In this case, Airline A's advertisement will “win” and be displayed in a more prominent position than Airline B's advertisement.

In accordance with embodiments of the present invention, voice-enabled text advertisements may be selected for presentation based on a variety of bid values and/or historical information. Advertisers may still submit a CPC bid and a CTR may still be associated with each voice-enabled text advertisement. In addition to traditional bid options such as bidding on clicks, user performance, or the like, advertisers may have an option to bid for a voice audio of an advertisement. A cost-per-voice (CPV) bid may be included in a calculation of a monetization value for a voice-enabled text advertisement. Advertisers may also bid for voice variations of traditional bid options including, for instance, a voice-CPC bid. For example, the advertiser may submit a voice-CPC bid for a voice-enabled text advertisement that is applied when the voice-enabled text advertisement is selected while the voice audio is activated and also submit a voice-CPC bid for the voice-enabled text advertisement that is applied when the voice-enabled text advertisement is selected while the voice audio is not activated. Voice audio activation, as used herein, refers generally to voice audio that has begun to audibly present the voice audio corresponding with the displayed text of the advertisement.

A variety of formulas may be used within various embodiments of the invention to calculate the monetization value of voice-enabled text ads. The formulas may incorporate a variety of different monetization factors to rank advertisements and, in turn, select text advertisements and voice-enabled advertisements for presentation (as will be discussed in further detail below).

In one aspect, an embodiment of the present invention is directed to one or more computer-readable media storing computer-useable instructions that, when used by one or more computing devices, cause the one or more computing devices to perform a method. The method includes receiving text of a first voice-enabled advertisement from an advertiser such that audio of a voice is generated from the text of the first voice-enabled advertisement prior to presentation to a user. The method further includes receiving an indication that the audio of the first voice-enabled advertisement is to be customized according to a customized voice selected by the advertiser. Audio is generated from the text of the first voice-enabled advertisement. The audio comprises the customized voice. The method still further includes storing the text of the first voice-enabled advertisement, the indication that the audio is to be customized, and the audio comprising the customized voice in an advertisement storage that contains a plurality of advertisements and related data. Additionally, the method includes receiving a request for one or more advertisements, and communicating a set of advertisements from the plurality of advertisements for presentation to the user, wherein the set of advertisements comprises the text of the first voice-enabled advertisement and the generated audio comprising the customized voice.

In another aspect, an embodiment of the present invention is directed to one or more computer-readable media storing computer-useable instructions that, when used by one or more computing devices, cause the one or more computing devices to perform a method. The method includes receiving from various advertisers a plurality of advertisements including text of a first advertisement that is voice-enabled. Voice of the first advertisement is to be customized. The method further includes, in association with the first advertisement, storing in an advertisement storage, text of the first advertisement, an indication that the first advertisement is voice-enabled such that audio corresponding to the text of the first advertisement is generated prior to presentation of the first advertisement to a user, and an indication that a voice associated with the audio of the first advertisement is to be customized based on content of the first advertisement. Further, the method includes, in response to the indications that the first advertisement is voice-enabled and that the voice associated with the audio is to be customized, algorithmically determining a customized voice for the audio of the first advertisement. The determination of the customized voice is based on the content of the first advertisement. Additionally, the method includes providing the audio generated from the text of the first advertisement based on the determined customized voice, and upon receiving a request for one or more advertisements, communicating a set of advertisements for presentation to the user. The set of advertisements includes the text of the first advertisement and the audio comprising the customized voice.

In a further aspect, an embodiment of the present invention is directed to one or more computer-readable media storing computer-useable instructions that, when used by one or more computing devices, cause the one or more computing devices to perform a method. The method includes receiving a request for one or more advertisements for presentation to a user, and identifying at least a first advertisement to present to the user. Also, the method includes determining that the first advertisement is voice-enabled and that a voice associated with audio of the first advertisement is to be customized. Both the text and the audio of a voice-enabled advertisement are presented to a user. Further, the method includes determining a first customized voice associated with the first advertisement. The determining is based on one or more of an indication of the first customized voice received from an advertiser associated with the first advertisement, or an algorithmical determination of the first customized voice based on content of the first advertisement. Additionally, the method includes accessing user preferences associated with the user to determine that the user has indicated a preference for a second customized voice for the first advertisement, and generating the audio from the text of the first advertisement, wherein the audio comprises the second customized voice. The text of the first advertisement and the audio comprising the second customized voice are communicated for presentation to the user.

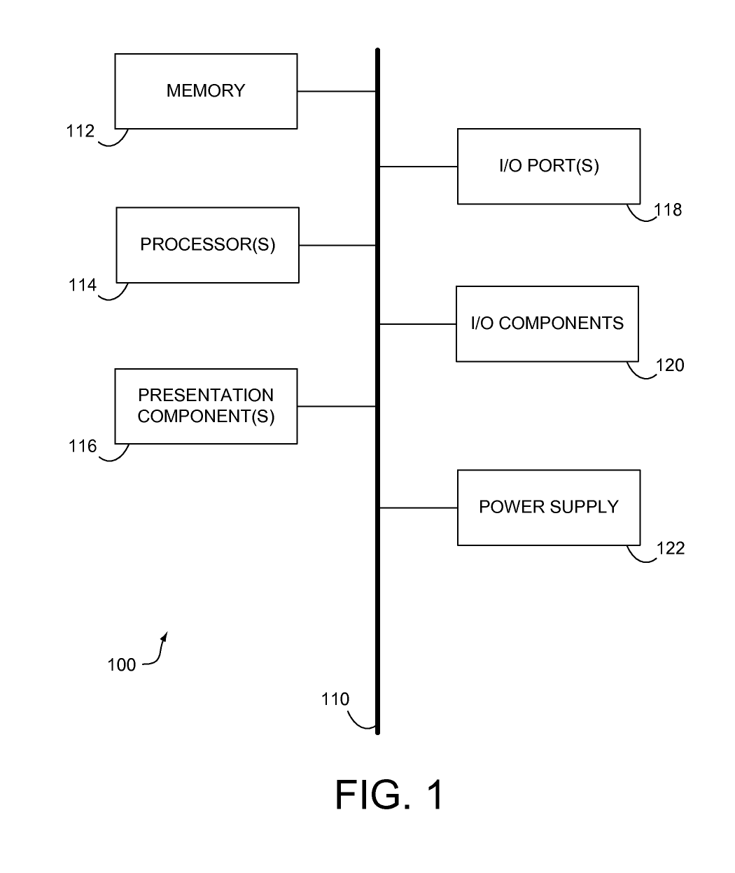

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

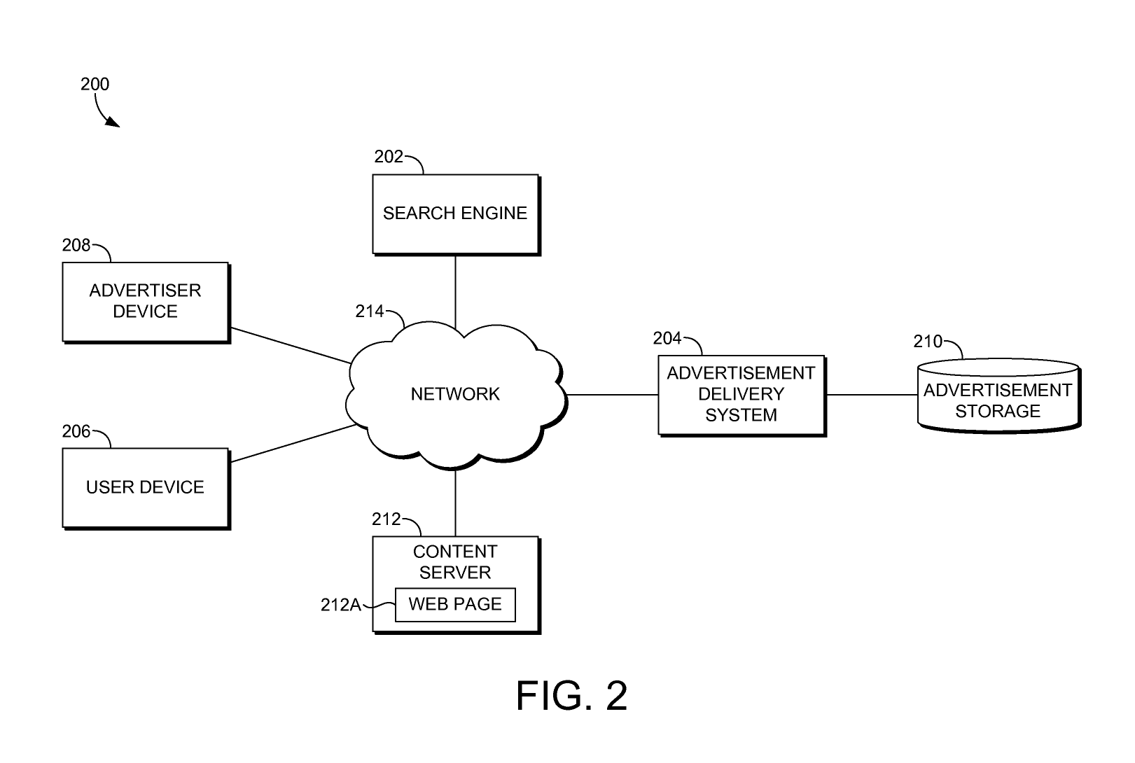

Referring now to FIG. 2, a block diagram is provided illustrating an exemplary system 200 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the system 200 includes a search engine 202, an advertisement delivery system 204, a user device 206, an advertiser device 208, an advertisement storage 210, and a content server 212. Each of the components shown in FIG. 2 may be any type of computing device, such as computing device 100 described with reference to FIG. 1, for example. The components may communicate with each other via a network 214, which may include, without limitation, one or more local area networks (LANs) and/or wide area networks (WANs). Such networking environments are commonplace in offices, enterprise-wide computer networks, intranets, and the Internet. It should be understood that any number of user devices, content servers, advertiser devices, search engines, and advertisement delivery systems may be employed within the system 200 within the scope of the present invention. Each may comprise a single device or multiple devices cooperating in a distributed environment. For instance, the search engine 202 and advertisement delivery system 204 may be part of a search system that comprises multiple devices arranged in a distributed environment that collectively provide the functionality of the search engine 202 and advertisement delivery system 204 described herein. Additionally, other components not shown may also be included within the system 200.

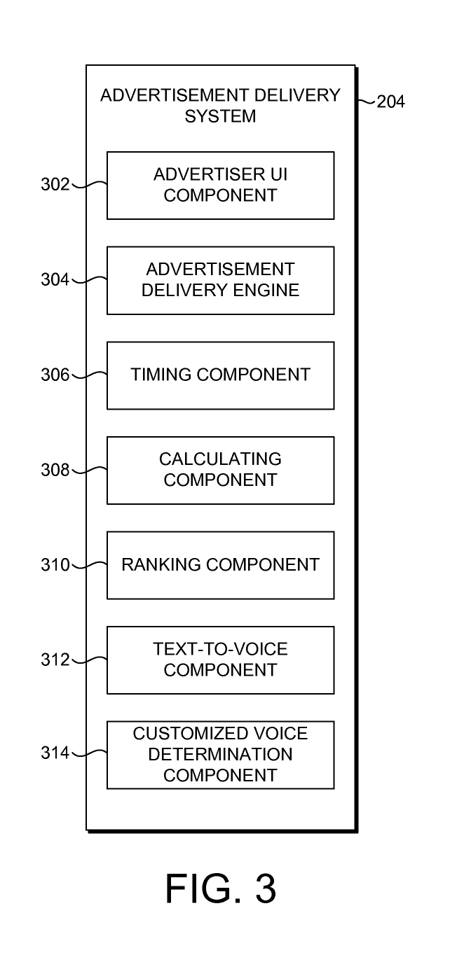

In accordance with embodiments of the present invention, the advertisement delivery system 204 generally operates to facilitate the selection and delivery of text advertisements and/or voice-enabled text advertisements to user devices, such as the user device 206. As shown in FIG. 3, the advertisement delivery system 204 includes, among other components not shown, an advertiser UI component 302, an advertisement delivery engine 304, a timing component 306, a calculating component 308, a ranking component 310, a text-to-voice component 312, and a customized voice determination component 314.

The advertiser UI component 302 generally provides one or more UIs to advertisers to allow the advertisers to interact with the advertisement delivery system 204. For instance, an advertiser may employ a computing device, such as the advertiser device 208, to access the advertiser UI component 302 of the advertisement delivery system 204 via network 214.

In one embodiment, the advertiser UI component 302 provides one or more UIs that allow an advertiser to create a new advertising campaign and/or edit an existing advertising campaign. The UI(s) provided for creating and/or editing an advertising campaign allows the advertiser to specify information for the advertising campaign. This may include submitting and/or editing information for one or more advertisements. For instance, the UI(s) may allow the advertiser to provide the text for an advertisement. Additionally, the UI(s) may allow the advertiser to select from multiple options for the advertisement. In accordance with some embodiments of the present invention, one option that may be selected by the advertiser is to indicate whether the advertisement is to be delivered as a text advertisement or a voice-enabled text advertisement. If the advertiser indicates that the advertisement is to be a text advertisement, only text is provided when the advertiser's advertisement is selected for presentation (as will be discussed in further detail below). Alternatively, if the advertiser indicates that the advertisement is to be a voice-enable text advertisement, text and voice is provided when the advertiser's advertisement is selected for presentation (as will be discussed in further detail below).

Another option that may be selected by the advertiser on the UI(s) is to indicate whether the voice associated with the audio of the advertisement is to be customized. In one embodiment, when the text of a voice-enabled advertisement is converted to audio, the audio may comprise a customized voice, such as a male voice, a female voice, a child's voice, a senior citizen's voice, a robot's voice, an alien's voice, etc., or a combination thereof. Further, the customized voice may include one or more types of voices in combination, such as starting with a female voice, switching to a child's voice, etc. In some embodiments, the advertiser selects an option for a customized voice, and may even select the particular voice to which the text is to be converted. For instance, the advertiser may submit an advertisement associated with a toy store. As such, the advertiser may select that this advertisement is to be voice-enabled, and that a child's voice is to be used for the generated audio. In other embodiments, the particular customized voice is algorithmically determined, as will be discussed below, and as such, the advertiser may not indicate the customized voice on the UI(s).

In an embodiment, the advertiser UI component 302 provides one or more UIs that allow an advertiser to submit bids for text advertisements and voice-enabled text advertisements. If the advertiser has indicated that the advertisement is to be delivered as a text advertisement, various bid factors are available via the one or more UI(s) provided by the advertiser UI component 302 including, but not limited to, CPC bids, cost-per-performance (CPP) bids, CPI bids, and the like. A CPC bid, as used herein, refers to an amount an advertiser is willing to pay each time their ad is selected or “clicked” by a user. A CPP bid, as used herein, refers to an amount an advertiser is willing to pay once a user performs some action after selecting their advertisement. For instance, a user may purchase the advertiser's product upon selecting the advertisement. A CPI bid, as used herein, refers to an amount that an advertiser is willing to pay for each impression of their advertisement, i.e., each time their advertisement is displayed.

If the advertiser has indicated that the advertisement is to be delivered as a voice-enabled text advertisement, a variety of voice-enabled text advertisement bid factors, in addition to the factors described above, are available for an advertiser to submit a bid via the one or more UI(s) provided by the advertiser UI component 302 including, but not limited to, a cost-per-voice (CPV) bid, a voice-CPC bid while a voice is activated, a voice-CPC bid while the voice is not activated, and combinations thereof. In embodiments, the advertiser may also submit a bid for a customized voice audio for a voice-enabled text advertisement.

Accordingly, advertisers may bid on a variety of factors including impressions, clicks, voice audio, or a combination thereof. Additional bids submitted by the advertiser for voice audio of an advertisement may increase the monetization value of the advertisement. Thus, the likelihood that the advertisement will be selected for presentation may, in turn, be increased.

A CPV bid may indicate an amount that an advertiser is willing to pay for a voice audio to be associated with a voice-enabled text advertisement. In some embodiments, the CPV bid may include a variety of sub-bids. For instance, an advertiser may submit a CPV bid representing an amount the advertiser is willing to pay for the voice audio of the advertisement when the voice audio has been activated but is not completed and may additionally submit an entirely different CPV bid for the advertisement when the voice audio has been activated and achieves a maximum completion level (i.e., the voice audio presentation is 100% complete). A completion level of a voice-enabled text advertisement may be determined by the advertisement delivery engine 304 (as will be discussed in further detail below). In some embodiments, an advertiser may submit a single CPV big indicating an amount the advertiser is willing to pay only if the entire voice audio is presented.

Similarly, an advertiser may submit a voice-CPC bid representing an amount the advertiser is willing to pay per click of a voice-enabled text advertisement. In some embodiments, the voice-CPC bid may also include sub-bids including, for example, a voice-CPC bid for a voice-enabled text advertisement that is clicked but the voice audio has not been activated and a voice-CPC bid for the voice-enabled text advertisement that is clicked when the voice audio has been activated. For instance, a voice-enabled text advertisement may be selected by a user before voice audio associated with the voice-enabled text advertisement has been activated. Alternatively, the voice-enabled text advertisement may be presented long enough to activate the voice audio but may be selected by a user prior to completion of the voice audio. Accordingly, the voice-CPC bid may vary depending on the completion level of the voice audio of the voice-enabled text advertisement. Exemplary voice-CPC bids depending on the completion level include a voice-CPC bid applied when the advertisement is selected while the voice audio is activated but not completed, a voice-CPC bid applied when the advertisement is selected and the voice audio has been activated and is completed, and the like.

Advertisement information entered by an advertiser via UI(s) provided by the advertiser UI component 302 is stored by the advertisement delivery system 204 in advertisement storage 210, referenced in FIG. 2. Accordingly, the advertisement storage 210 stores a variety of advertisements submitted by different advertisers, along with metadata for each advertisement that, among other things, facilitates selecting advertisements for presentation to users. In one embodiment, metadata is stored for each advertisement indicating whether the advertisement is to be voice-enabled, as selected by the advertiser who submitted the advertisement to the advertisement delivery system 204. For instance, an advertisement may be stored in the advertisement storage 210 with a metadata flag indicating that the advertisement is to be voice-enabled. This allows the advertisement delivery system 204 to distinguish between regular text advertisements and voice-enabled text advertisements.

Further, for advertisements that are flagged as voice-enabled, an indication may be included as to whether a customized voice is to be used when the audio is generated. In addition to the metadata stored in the advertisement storage 210 in relation to whether the advertisement is to be voice-enabled, metadata indicating whether the customized voice is to be used, or even a particular customized voice that comprises the audio, may also be stored in the advertisement storage 210. For example, an advertisement may be stored in the advertisement storage 210 with a metadata flag indicating that the advertisement is to be voice-enabled, as well as a metadata flag indicating that the voice is to be customized. In one embodiment, an indication as to a particular customized voice may also be stored in the advertisement storage 210. The particular customized voice, in one instance, is selected by the advertiser, but in another instance, is algorithmically determined by the customized voice determination component 314, for example.

In addition to storing the advertisements and related information in the advertisement storage 210, audio associated with the advertisements may also be stored in the advertisement storage 210. For instance, audio may be generated at different times for various advertisements. For example, audio may be generated at the time that a voice-enabled advertisement is submitted by an advertiser. Or, audio may be generated when the voice-enabled advertisement is first delivered for presentation to a user. For the latter, the audio is stored in the advertisement storage 210 and may be retrieved when another request is received for that same advertisement, such that the audio for the same advertisement is not generated multiple times. In one embodiment, the audio that is stored in the advertisement storage 210 comprises a customized voice that has been selected by an advertiser or algorithmically determined based on content of the advertisement or based on user information.

Advertisements may also be stored in the advertisement storage 210 with bidding information. The bidding information may be associated with a particular advertisement stored in the advertisement storage 210 upon receiving bidding information input by an advertiser in one or more UIs provided by the advertiser UI component 302.

The advertisement storage 210 may also store tracking data used for both billing advertisers and estimating a likelihood of clicks (i.e., a CTR) to calculate a monetization value for the advertisement. The tracking data may include advertisement presentation data to ensure that advertisers are only responsible for appropriate advertisement amounts. For instance, an advertiser may submit a voice-CPC bid causing the advertisement storage 210 to store click data associated with the advertisements including a number of clicks, a number of clicks when a voice-enabled text advertisement has achieved a partial voice audio, a number of clicks when a voice-enabled text advertisement has achieved a completed voice audio, or the like.

As previously mentioned, an impression of an advertisement does not necessarily mean that the voice audio has been completed or that the voice audio has been activated at all. Timing data, acquired by a timing component 306, for each advertisement may be used to determine appropriate advertisement amounts and may be stored in the advertisement storage 210. Each voice-enabled text advertisement will have a voice audio associated with it and will require a predetermined completion time to achieve 100% completion of the voice audio. Accordingly, once a voice-enabled text advertisement is presented, the timing component 306 determines the predetermined completion time associated with the voice audio of the voice-enabled text advertisement and an actual display time such that it may be determined if a maximum completion level was achieved, the voice audio was not activated at all, or if the voice audio was activated but achieved a completion level greater than zero but less than 100%. In embodiments, advertisers may only be responsible for payment of voice audio that achieved a maximum completion level (i.e., a 100% completion level). In further embodiments, advertisers may be responsible for bids on voice audio that achieved less than a maximum completion level on, for example, a pro-rated basis.

The timing component 306 may be configured to begin timing the actual display time in response to a variety of indicators. For example, an advertisement displayed in a prominent or primary position may have an actual display time that begins as soon as it is displayed since it is the first advertisement that may activate voice audio. An advertisement displayed in a less prominent position may have an actual display time that begins, for example, when the voice is actually activated, rather than from the first moment of impression. Such timing customization may, among other things, facilitate more accurate tracking of timing data used to determine appropriate advertisement amounts to allocate to advertisers.

Click information may also be stored in association with the advertisements such that it is easily determined how many times a particular advertisement has been selected, how many times it has been selected while the voice audio has been activated but not completed, how many times it has been selected while the voice audio has been activated and is completed, or the like. The advertisement storage 210 may also store a particular advertisement's CTR in association with that advertisement.

The advertisement delivery engine 304 facilitates selection and delivery of advertisements to user devices, such as the user device 206. Selecting advertisements may be based on any of a variety of different factors, including, for instance, contextual relevance and monetization considerations.

Monetization considerations may include a variety of factors including, but not limited to, CTR's, CPV bids, CPC bids, voice-CPC bids, or a combination thereof. Various embodiments of the present invention may use different combinations of these factors. A monetization value, as used herein, refers to an amount of revenue that an advertisement delivery system may expect as a result of displaying a particular advertisement. Typically, monetization values have been calculated for text advertisements using CPC bids and CTR's. Once a monetization value is calculated for text advertisements, the text advertisement with the highest monetization value may be presented in the most prominent position.

Voice-enabled text advertisements may utilize a pricing model that includes multiple monetization factors that may be relevant to both text advertisements and voice-enabled text advertisements. Monetization factors that may be considered while calculating the monetization value include, but are not limited to, a CTR for advertisements having voice audio but without voice audio activation, a CTR for advertisements having voice audio activation and a maximum completion level, a CTR for an advertisement having voice audio activation and less than a maximum completion level, a CTR for advertisements without voice audio, a CPV for an advertisement having voice audio and a maximum completion level, a CPV for an advertisement having voice audio and less than a maximum completion level, a CPI, a CPC for an advertisement without voice audio, a voice-CPC for an advertisement with voice audio but without voice audio activation, a voice-CPC for an advertisement with voice audio activation and a maximum completion level, a voice-CPC for an advertisement with voice audio activation and less than a maximum completion level, and the like.

Based on any combination of one or more of the above monetization factors, a calculating component 308 may calculate a monetization value for both text advertisements and voice-enabled text advertisements. The calculations for determining a monetization for voice-enabled text advertisements may include, but are not limited to, various combinations of the above monetization factors. For instance, the monetization value may be calculated by finding a product of the CPC bid and the CTR, finding a product of the voice-CPC bid and the voice-CTR (i.e., CPC(v)×CTR(v)), or the like. A monetization value of text advertisements will not include monetization factors specific to voice-enabled text advertisements (e.g., CPV).

In a specific embodiment, a monetization value may be calculated using, for instance, the following equation:

MV(v)=CPV/1000+CPC(v)*CTR(v)

Wherein MV(v) represents the monetization value of a voice-enabled text advertisement, CPV/1000 is the cost-per-voice that the advertiser has bid for voice audio per every one thousand times the voice audio is played, CPC(v) is the voice-cost-per-click bid submitted by the advertiser for the voice-enabled text advertisement, and CTR(v) is the voice-click-through-rate for the voice-enabled text advertisement. The CPC(v) may be based on clicks while the voice audio is activated, while the voice audio is not activated, once the voice audio has completed, or the like.

The multiple variable possibilities for the voice-CPC allows for a variety of calculations to find the CTR(v). The CTR(v) may be calculated, for instance, by dividing a number of clicks of the voice-enabled text advertisement by a number of impressions of the voice-enabled advertisement. As previously explained, the number of clicks and the number of impressions may depend on a completion level of the voice-enabled text advertisement. For instance, the number of impressions may include anytime the advertisement is presented and the voice audio is activated while the number of clicks may only include clicks on the advertisement while the voice audio is activated. A variety of formulas may be used within various embodiments of the invention.

Once a monetization value has been calculated for each of one or more text advertisements and/or one or more voice-enabled text advertisements, the advertisements may be ranked by a ranking component 310 according to their respective monetization values in order to select the advertisements to present and/or the advertisements to present in a prominent position. In an embodiment, there may be no advertisement that is suitable for presentation and, thus, no advertisement may be selected for presentation. In another embodiment, the advertisement having the highest monetization value may receive the highest ranking value and, accordingly, may be presented in the most prominent advertisement position as a primary advertisement. In additional embodiments, both text advertisements and voice-enabled text advertisements may be selected to be presented. For instance, a text advertisement may be associated with very high bid values including, for instance, a high CPC bid. Meanwhile, a competing voice-enabled text advertisement may be associated with more bids than the text advertisement. The bids of the voice-enabled text advertisement may be lower in value than the high value for the CPC bid for the text advertisement. The text advertisement may, as a result, have a higher monetization value and be presented with the voice-enabled text advertisement. Thus, in some embodiments, a plurality of advertisements, including both text advertisements and voice-enabled text advertisements, may be selected for simultaneous presentation.

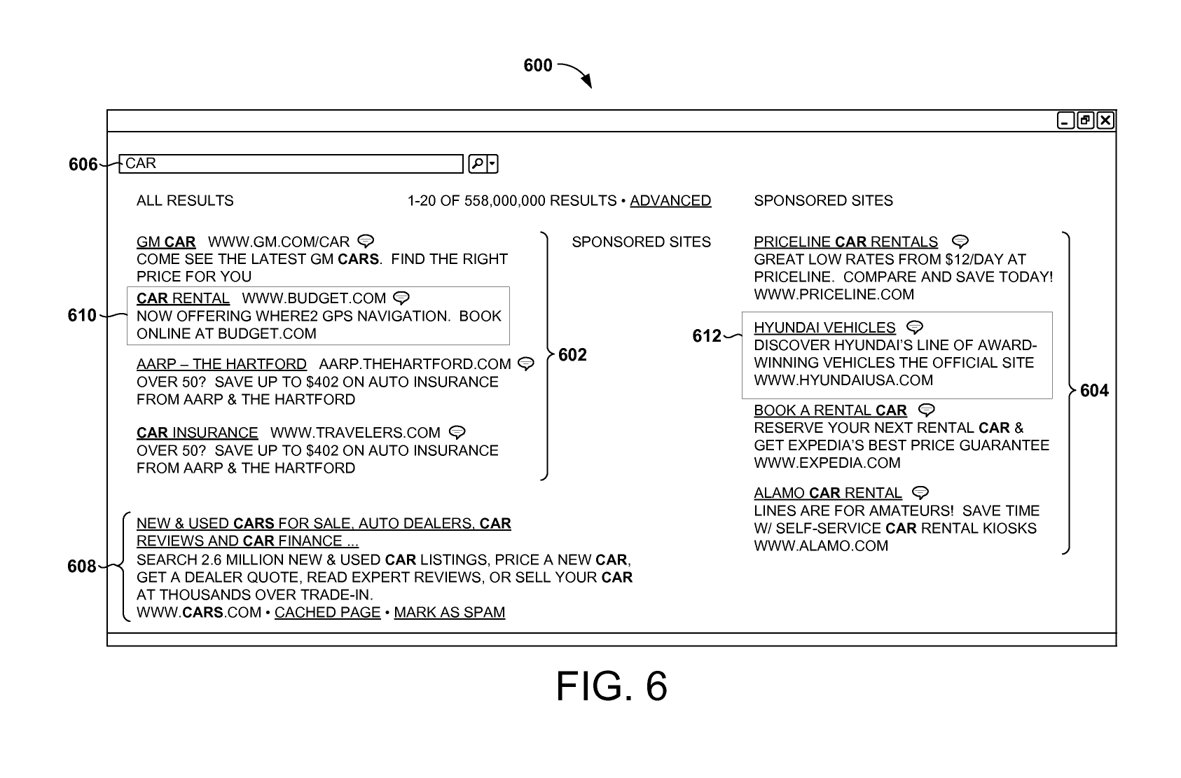

The advertisement delivery engine 304 may utilize the ranking values of the ranking component 310 to select text advertisements and voice-enabled advertisements based on monetization values, contextual relevance, and/or other factors. The advertisement delivery engine 304 may be configured to select the highest ranking advertisement to present or, alternatively, may be configured to select the top N ranking advertisements, where N may be any number. The advertisement with the highest ranking value may be selected to be displayed as a primary advertisement, i.e., to be positioned in a prominent position (e.g. the top and center of a display or near the top of a list of advertisements). Additional advertisements may be selected to be displayed as secondary advertisements that are not in the most prominent position but are still selected for presentation. FIG. 6 is an illustrative interface illustrating a prominent advertisement display area 602 and a secondary advertisement display area 604. Advertisements selected as primary advertisements may be presented in the prominent advertisement display area 602 and other selected advertisements may be presented in the secondary advertisement display area 604.

In embodiments, a price estimation may be given to advertisers as a guide for an estimated price associated with a particular advertisement or, alternatively, may be used to calculate the actual costs associated with an advertisement. Price estimations may depend on a position assigned to an advertisement (e.g., a prominent position), as well as numerous other factors including, but not limited to, CPC, CPV, and combinations thereof. Additional factors that may affect the price estimation may include historical information of an advertisement and/or an advertiser. For example, an advertisement that has been previously presented has historical data associated therewith including a click-through-rate, an amount of clicks for a previous month, and the like. Actual costs of advertisements may also be calculated using an actual click-through-rate, an actual number of clicks for a previous month, and the like. Thus, an advertiser's actual data may be used to provide an actual cost of an advertisement or to provide an estimated cost of the advertisement for the future.

Price estimations may be performed for advertisements lacking historical data. For instance, rather than calculating the price estimation with a known number of clicks for a previous time period, the price estimation calculation may be performed using an estimate of a number of clicks, an average number of clicks for similar advertisements, or the like.

In order to calculate a price estimation, a potential number of clicks should be identified. As previously explained, the potential number of clicks may be based on historical data of an advertisement and/or advertiser. In embodiments, the potential number of clicks may be based on an estimated number of clicks. In further embodiments, the potential number of clicks may be calculated using a monetization value of the advertisement and a CTR for the advertisement. For instance, an estimated number of times an advertisement may be selected may be based on the monetization value of the advertisement.

A CTR for an advertisement may be adjusted depending on the position of the advertisement. For instance, an advertisement in a more prominent position has a higher likelihood to be clicked than an advertisement in a less prominent position. Thus, the more prominent advertisement may be clicked or selected more often and, in turn, the CTR will vary depending on the position of the advertisement. While calculating a price estimation for an advertiser, adjustments to the CTR may be estimated depending on a position of an advertisement. Thus, a desired position may be identified for which to perform a price estimation and the CTR may be adjusted to reflect the desired position. In embodiments, the CTR may be adjusted depending on a position of a text advertisement and depending on a position of a voice-enabled text advertisement.

Once a potential number of clicks has been estimated, a price estimate calculation may be performed for any timeframe relevant to an advertiser (e.g., a monthly price estimate, a yearly price estimate, a weekly price estimate, etc.) In a specific embodiment, a price estimation may be performed for an advertiser using, for instance, the following equation:

Monthly $=I*CPI/1000+V*CPV/1000+C*CPC

Wherein Monthly $ represents an estimated monthly amount owed by the advertiser, I is a number of impressions, CPI/1000 is a cost-per-impression bid per every 1000 times the advertisement is displayed, V is a number of times voice audio is presented, CPV is a cost-per-voice bid submitted by the advertiser, C is a number of clicks, and CPC is a cost-per-click bid submitted by the advertiser. In the above exemplary equation, the CPI and CPV bids are calculated as the cost-per-impression bid and/or cost-per-voice bid per 1000 times the advertisement has been displayed or the voice audio has been presented or will be presented. Alternatively, the CPI and/or CPV could be calculated for N number of times the advertisement is displayed and/or the advertisement voice audio is presented, wherein N is any number. Additionally, the calculation could be performed using the CPV for when the voice audio has a maximum completion level and when the voice audio has a completion level less than 100%.

In embodiments, the number of clicks (C) may be a potential number of clicks estimated for the advertisement or a potential number of clicks based on historical data. In other embodiments, the number of clicks may represent a potential number of clicks calculated using the monetization value and the adjusted CTR, as previously discussed.

As with the calculation for the monetization value, the price estimation calculation may be calculated for a variety of scenarios including presentations of a complete voice audio, presentations of a partial voice audio, CPC's while voice audio is activated but not completed, CPC's while the voice audio has completed, or the like.

The advertisement delivery engine 304 delivers selected advertisements for presentation to users on user devices, such as the user device 206. When delivering advertisements, the advertisement delivery engine 304 identifies whether any advertisements are voice-enabled. For instance, the advertisement delivery engine 304 may identify a selected advertisement as being voice-enabled based on a metadata flag stored with metadata for the advertisement indicating that the advertisement is to be voice-enabled.

A text-to-voice component 312 is employed to generate voice audio from the text of an advertisement. The text-to-voice component 312 may generally comprise a text-to-speech system capable of creating a computer-generated voice corresponding to text of an advertisement. Although the text-to-voice component 312 is shown as part of the advertisement delivery system 204, in embodiments, the text-to-voice component 312 may be provided by the search engine 202 or another network component not shown in FIG. 2 and the advertisement delivery system 204 may simply include an API to request text-to-voice conversion.

In some embodiments, the text of a voice-enabled text advertisement may be converted to voice by the text-to-voice component 312 after the advertisement has been selected for delivery. In other embodiments, the text of a voice-enabled text advertisement may be converted to voice by the text-to-voice component 312 and stored in association with the advertisement in the advertisement storage 210 or other storage location. In such embodiments, when a voice-enabled text advertisement is selected for delivery, the stored voice may be retrieved for delivery such that generation of voice is not required at that time.

A customized voice determination component 314 is employed to determine if a customized voice is to be used when audio is generated from text of the advertisement, and further, if a customized voice is to be used, which customized voice is to be used for the audio, such that the audio comprises the customized voice. Generally, an indication is received from the advertiser that an advertisement is to be treated as voice-enabled, such that the text is converted to audio prior to presentation to the user. In addition to this, an indication may be received that a customized voice is to be associated with a particular advertisement. This indication, in one embodiment, is received by the advertiser such that the customized voice determination component 314 determines, based on this indication, which customized voice to use. The advertiser may select a particular customized voice that is to be used for the submitted advertisement. For example and not limitation, customized voices may include a female voice, a male voice, a child's voice, a senior citizen's voice, an alien-sounding voice, a robot-sounding voice, etc., or a combination thereof.

Alternatively, in another embodiment, the advertiser may simply indicate that a customized voice is to be used, but may not indicate a particular customized voice. As such, the customized voice determination component 314 algorithmically determines which customized voice to use based on, for instance, content of the advertisement. For example, a senior citizen's voice may be algorithmically determined for an advertisement directed to a nursing home. A child's voice, on the other hand, may be algorithmically determined for an advertisement directed to a toy store. Additionally, a female voice may be determined for an advertisement directed to a nail salon. The algorithm associated with the customized voice determination component 314 includes logic that is able to make this determination. Predetermined categories, for instance, may each correspond to various key words. When a particular key word is extracted from text of an advertisement, that key word may be matched or paired to a key word in one or more of the categories, and a customized voice associated with that category may be selected.

In yet another embodiment, even if the advertiser has selected a customized voice for the advertisement, or if the customized voice determination component 316 has algorithmically determined a customized voice for the advertisement, user preferences override either of these customized voice selections. For instance, a user may indicate in the user preferences that a woman's voice is to be used at all times for all advertisements. If the customized voice determination component 314 has determined that, based on the content of the advertisement, a man's voice is to be used, a woman's voice will ultimately be selected, as in this embodiment, the user's preferences override all other customized voice selections.

The advertisement delivery system 204 may be configured to deliver text advertisements and/or voice-enabled text advertisements within a number of different environments. For instance, advertisements may be delivered in conjunction with search results, on web pages, or within other electronic environments. In one embodiment, the advertisement delivery system 204 is configured to operate in coordination with a search engine 202 to provide advertisements in conjunction with search results in response to user queries from user devices, such as the user device 206. In such embodiments, a user may employ the user device 206 to enter a search query and submit the search query to the search engine 202. For instance, the user may employ a web browser on the user device 206 to access a search input web page of the search engine 202 and enter a search query. As another example, the user may enter a search query via a search input box provided by a search engine toolbar located, for instance, within a web browser, the desktop of the user device 206, or other location. One skilled in the art will recognize that a variety of other approaches may also be employed for providing a search query within the scope of embodiments of the present invention.

When the search engine 202 receives a search query from a user device, such as the user device 206, the search engine 202 performs a search on a search system index to identify relevant search results. Additionally, the advertisement delivery system 204 operates on the received search query and/or identified search results to select advertisements based on contextual relevance and/or monetization. In response to the search query, a search results page is provided to the user device 206 that includes search results and advertisements. Any voice-enabled text advertisements that have been selected are identified, and voice for each voice-enabled text advertisements is provided for presentation with the search results page.

In another embodiment, advertisements may be selected and presented on web pages, such as the web page 212a, hosted by the content server 212. For instance, the web page 212a may include an area for presenting advertisements delivered by the advertisement delivery system 204. In some embodiments, the advertisement delivery system 204 may select advertisements by analyzing the content of the web page 212a and selecting advertisements relevant to the content of the web page 212a. Advertisements may also be selected for the web page 212a based on monetization. When a user requests the web page 212a from the content server 212 using, for instance, a web browser on the user device 206, the web page 212a is provided to the user device for presentation to the user. Any voice-enabled text advertisements that have been selected are identified, and voice for each voice-enabled text advertisements is provided for presentation with the web page.

Although delivery of voice-enabled advertisements has been discussed with reference to FIG. 2 in the context of search results and web pages, it should be understood that these are provided as examples only. As previously indicated, voice-enabled advertisements may be provided in other electronic advertising environments (e.g., on-line games, advertising-supported software applications, emails etc.) within the scope of embodiments of the present invention.

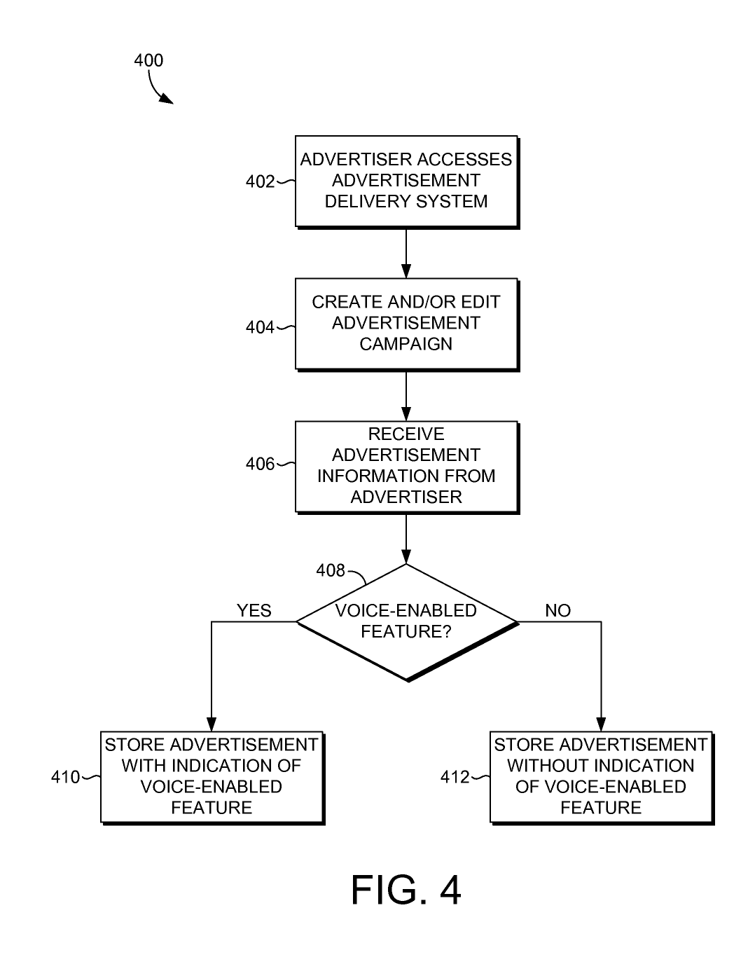

Referring now to FIG. 4, a flow diagram is provided that illustrates a method 400 for generating and storing an advertisement at an advertisement delivery system in accordance with an embodiment of the present invention. Initially, an advertiser accesses the advertisement delivery system, as shown at block 402. For instance, the advertisement delivery system may provide one or more UIs that allow advertisers to interact with the advertisement delivery system. The advertiser may interact with the UIs provided by the advertisement delivery system to create and/or edit an advertisement campaign, as shown at block 404.

The advertiser provides information for an advertisement, which is received by the advertisement delivery system, as shown at block 406. The information provided for the advertisement may include text for the advertisement, as well as additional information and option selections for the advertisement. In accordance with the present embodiment, information received at block 406 includes an indication of whether the advertiser wishes the advertisement to be a text-only advertisement or a voice-enable text advertisement. Further information for an advertisement may also be provided at block 406. For instance, an advertiser may supply bid information for monetization/advertisement selection purposes and/or voice customization information at block 406, as well as a variety of additional information for the advertisement.

Accordingly, the advertisement delivery system determines at block 408 whether the advertiser has selected the voice-enabled feature for the advertisement. If it is determined that the advertiser has selected the voice-enabled option, the advertisement is stored at block 410 with an indication that the advertisement is voice-enabled. For instance, the advertisement may be stored with a metadata flag indicating the advertisement as being voice-enabled. Alternatively, if it is determined that the advertiser has not selected the voice-enable option, the advertisement is stored at block 412 without an indication that the advertisement is voice-enabled.

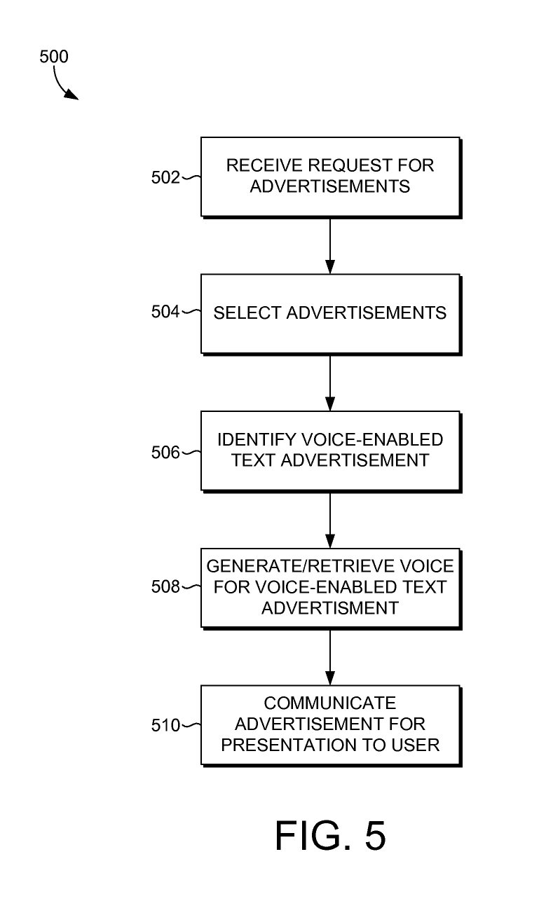

Turning to FIG. 5, a flow diagram is provided that illustrates a method 500 for selecting and providing advertisements in accordance with an embodiment of the present invention. As shown at block 502, a request for advertisements is received. The request for advertisements may be received from a variety of different applications in which electronic advertisements may be delivered (e.g., search, web page, video games, etc.). For instance, in one embodiment, a request for advertisements is received from a search engine providing a search results page in response to a search query. When the search query is received, one or more keywords may be identified based on the search query and/or search results that may be used for advertisement selection. In another embodiment, a request for advertisements is received for providing advertisements on a web page. The request may include an indication of a web page such that keywords may be identified from the content of the web page. Alternatively, the web page may have already been analyzed, and the request may include one or more keywords for advertisement selection.

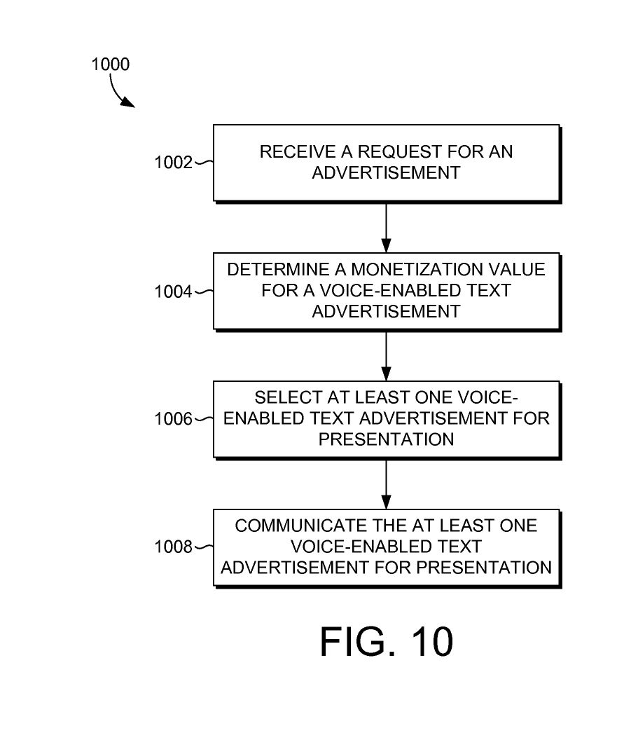

One or more advertisements are selected in response to the request for advertisements, as shown at block 504. Advertisements may be selected based on a number of different factors within the scope of embodiments of the present invention. In some embodiments, the advertisements may be selected based on contextual relevance to the environment in which the advertisements are to be presented. For instance, as noted above, the request may include keywords derived for a search query or web page or information that allows for the identification of keywords. The keywords may be used to select relevant advertisements for delivery. Additionally or alternatively, in some embodiments, advertisements may be selected based on monetization factors, for instance, using the method 1000 described in detail below with reference to FIG. 10.

Advertisement selection may include ranking a number of candidate advertisements based on factors, such as contextual relevance and monetization, and selecting the advertisements based on the rankings. In some embodiments, a predetermined number of advertisements are selected. For instance, the search system may select the five advertisements with the highest ranking. In other embodiments, all advertisements having a ranking satisfying a predetermined or dynamic threshold may be selected. In further embodiments, advertisements having a significantly higher ranking than other advertisements are selected. Any combination of the above and/or additional approaches to selecting advertisements based on ranking may be employed within embodiments of the present invention.

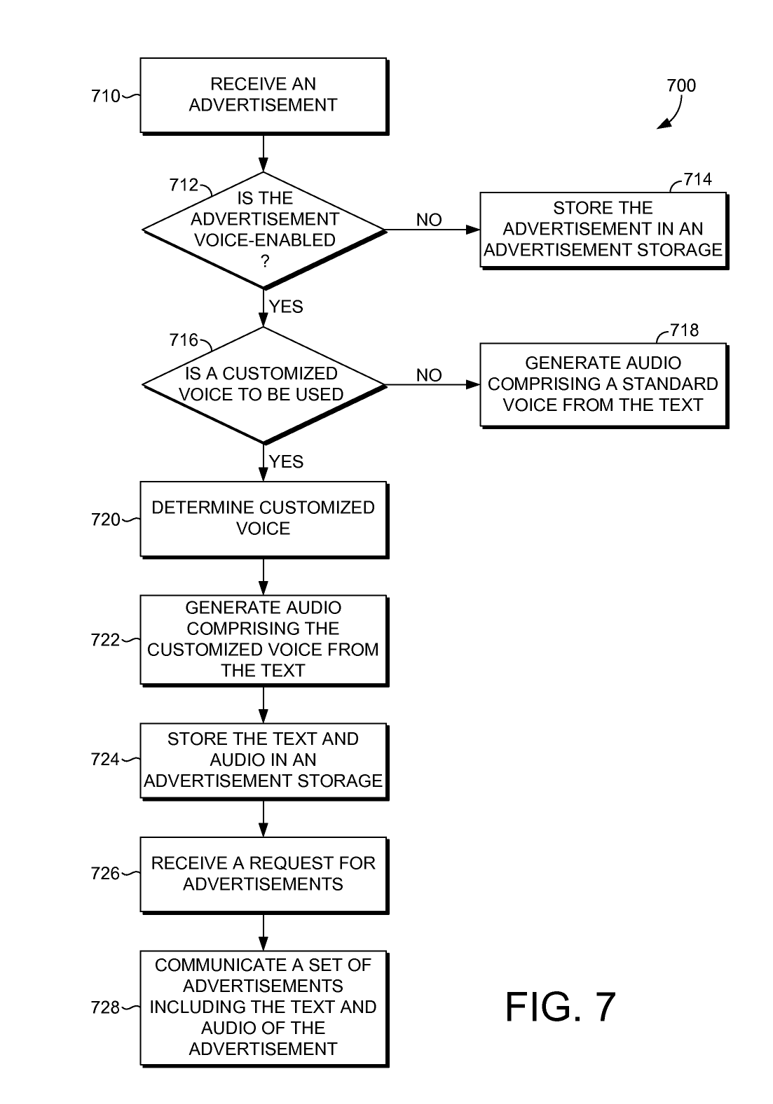

Advertisements selected at block 504 are analyzed to determine if there are any voice-enabled text advertisements included. When a voice-enabled text advertisement is identified at block 506, voice for the voice-enabled text advertisement is generated or retrieved, as shown at block 508. In some embodiments, the advertisement delivery system may store only text for voice-enable text advertisements. Accordingly, when a voice-enabled text advertisement is selected, voice is generated for the advertisement by applying a text-to-voice component to convert the text of the advertisement to voice. Generating voice for a voice-enabled text advertisement in some embodiments may include determining a particular voice for the advertisement, for instance, such as in methods 700, 800, and 900 described below with reference to FIGS. 7, 8, and 9, respectively. In other embodiments, the advertisement delivery system may store (or at least cache for a period of time) voice for at least some advertisements. In such embodiments, the advertising system may simply retrieve the stored voice for the advertisement at block 508. If customized voice is employed, the advertisement delivery system, and in particular the customized voice determination component 314, may determine the desired customized voice and identify whether that customized voice is stored. If stored, the customized voice is retrieved at block 508. Otherwise, the customized voice is generated at block 508.

The selected advertisements are delivered for presentation to the user, as shown at block 510, within the environment for which the advertisements were selected. For instance, within the context of search, the advertisements are included in a search results page provided in response to a search query. For a web page, the advertisements are delivered for presentation at a location provided on the web for advertisements.

Delivery of the advertisements includes delivering the text of each advertisement and the voice audio for any voice-enabled text advertisements. The advertisements provided on the search results page may include a mix of text advertisements and/or voice-enabled text advertisements. In an embodiment, the text of each advertisement is displayed. Additionally, voice corresponding with any voice-enabled text advertisement is audibly presented to the user. If there is more than one voice-enabled text advertisement, in one embodiment, the voice for each voice-enabled text advertisement is presented sequentially, for instance, based on ranking of the advertisements. In some embodiments, voice-enabled text advertisements are displayed visually different from text-only advertisements to allow the user to more quickly identify the displayed text corresponding with the voice being audibly presented.

By way of illustration, FIG. 6 includes an exemplary screen display showing a search results page 600 including voice-enabled text advertisements generated in accordance with an embodiment of the present invention. It will be understood and appreciated by those of ordinary skill in the art that the screen display of FIG. 6 is provided by way of example only and is not intended to limit the scope of the present invention in any way.

As shown in FIG. 6, the search results page 600 has been provided in response to the search query 606, “car.” In response to the search query 606, the search results page 600 includes a search results area 608 for displaying search results relevant to the search query 606. The search results page 600 also includes advertisement areas 602 and 604 presenting the text of selected advertisements. In accordance with embodiments of the present invention, the advertisements have been selected based on the search query 606 and/or search results. In the example of FIG. 6, the advertisements 610 and 612 are voice-enabled text advertisements and the text of the advertisements 610 and 612 have been boxed in the search results page 600 to indicate that the advertisements 610 and 612 are voice-enabled. When the search results page 600 is displayed to the user, voice corresponding with the advertisements 610 and 612 is audibly presented. In an embodiment, the voice corresponding with each of the advertisements 610 and 612 is audibly presented in sequence based on the advertisement rankings. For instance, advertisement 610 may have been determined to have a higher ranking than advertisement 612, thereby resulting in the advertisement 610 being presented in a more prominent position on the search results page 600. As such, the voice of advertisement 610 would be audibly presented first followed by the voice of advertisement 612.

In embodiments, the advertisement areas 602 and 604 may be identified as the prominent advertisement display area 602 and the secondary advertisement display area 604. The prominent advertisement display area 602 may include text advertisements or voice-enabled text advertisements that have been selected as primary advertisements. The secondary advertisement display area 604 may include text advertisements or voice-enabled text advertisements that have been selected as secondary advertisements.

Referring to FIG. 7, a flow diagram is shown illustrating a method 700 for customizing a voice associated with audio of an advertisement based on an indication received by an advertiser, in accordance with an embodiment of the present invention. Initially, an advertisement is received at step 710. More particularly, text of a first voice-enabled advertisement may be received from an advertiser. The advertisement, in one embodiment, may comprise only text when it is received. At step 712, it is determined whether the advertisement is voice-enabled. As mentioned above, a voice-enabled advertisement is an advertisement that can be both visually and audibly presented to a user. The audio may be generated from the text of the advertisement prior to presentation of the advertisement to a user. An advertiser, in one embodiment, is presented with multiple options (e.g., by way of the advertiser UI component 302 discussed herein in relation to FIG. 3) that allow for input of various types of information associated with the submitted advertisement, and this information may include whether or not the advertisement is to be treated as voice-enabled. If it is determined that the advertisement is not voice-enabled, the text of the advertisement is stored in an advertisement storage, shown at step 714. In addition to the text of the advertisement, an indication that the advertisement is not voice-enabled may also be stored. The indication may be in the form of a metadata flag, for example.

If it is determined that the advertisement is voice-enabled, it may then be determined at step 716 whether a customized voice is to be used for the voice audio of the advertisement. This determination may be made in one of several ways. In one embodiment, the advertiser that has submitted the advertisement may indicate on a UI, which may be provided by way of the advertiser UI component 302 discussed herein in relation to FIG. 3, that a customized voice is to be used. If it is determined that a customized voice is not to be used, audio is generated at step 718. The audio, generated from the text of the advertisement by way of the text-to-voice component 312, for instance, comprises a standard voice. A standard voice, as used herein, comprises a default voice that does not change or vary from one advertisement to another advertisement. The default voice is typically predetermined and is the same voice over multiple advertisements that are not to have a customized voice. In one embodiment, the standard voice is a default male voice. If, on the other hand, the advertiser has indicated that an option for a customized voice, then it is determined that a customized voice is to be used, and the customized voice is determined at step 720.

A customized voice may be determined by either the advertiser, or it may be determined by the advertisement delivery system 204, and in particular, the customized voice determination component 314. In the scenario where the customized voice is determined by the advertiser, the advertiser may be presented with a plurality of customized voice options on the advertiser UI at the time when the advertiser is submitting an advertisement. Customized voices include, for example, a female's voice, a male's voice, a child's voice, a senior citizen's voice, a robot-sounding voice, an alien-sounding voice, etc. This list is not meant to be inclusive, but rather a sampling of many voices from which an advertiser may select from. The advertiser may not be given an option to select a customized voice, or may prefer not to select one. In these cases, the customized voice determination component 314 may algorithmically determine the customized voice based on, for example, content of the advertisement. Content, as used herein, may include any text associated with the advertisement, such as a title of the advertisement, or actual text of the advertisement.

In one embodiment, key words are extracted from the text of the advertisement by a data searching and extraction method, such as data mining. Key words found may be matched with key words previously determined to be associated with a particular category. Each category may have one or more associated customized voices. For example, a submitted advertisement may have five key words that are extracted by, for example, the customized voice determination component 314 described herein with reference to FIG. 3. In one instance, three of the five key words may belong to a particular category having an associated customized voice of a woman's voice. In this instance, a woman's voice may be chosen as the customized voice for the submitted advertisement.

At step 722, audio comprising the determined customized voice is generated from the text of the advertisement. In one embodiment, the audio is generated by the text-to-voice component 312 described herein with reference to FIG. 3. Once the text-to-voice component 312 receives the text of an advertisement, it may retrieve from a storage the specific customized voice that is to be used for the voice audio of that advertisement. The audio may be generated at different times throughout the process of receiving an advertisement to presenting that advertisement to a user. In one embodiment, audio of an advertisement is generated as soon as the text of the advertisement is received from an advertiser. The audio and text and other information associated with the advertisement may then be stored for future retrieval. Alternatively, in another embodiment, the audio is not generated until a request has been received (e.g., from a search engine or other web page) for that particular advertisement. Here, the audio would be generated in real-time once it is requested. In yet another embodiment, there may not be a need for generating audio, as it may have already been generated in association with another request for that advertisement. The audio may simply be retrieved from storage and audibly presented to the user.

The text and the audio are stored in an advertisement storage at step 724. As described above, the time in the process at which the audio is generated determines when the audio is stored in the advertisement storage. In addition to the text and audio, the indication as to whether the advertisement is voice-enabled, as well as the indication as to whether the audio is to be customized to a particular voice. The advertisement storage may contain a plurality of advertisements that have been submitted by various advertisers. At step 726, a request is received for one or more advertisements. A set of advertisements of the plurality of advertisements stored in the advertisement storage may be retrieved from the advertisement storage, and is communicated for presentation to a user at step 728. For advertisements that are voice-enabled and whose audio comprises a customized voice, the audio comprising the customized voice is audibly presented to the user, and the text of the advertisement is visually presented to the user. In some embodiments, other forms of media are also presented to the user, including videos and images associated with the advertisement.

In a further embodiment, a text associated with a second voice-enabled advertisement is received. Similar to that described above, an indication that the voice associated with the audio of the second voice-enabled advertisement is to be customized is also received. Audio may then be generated based on the text of the second voice-enabled advertisement. In yet another embodiment, the text of a second voice-enabled advertisement is received. It may then be determined that an indication has not been received that the voice associated with the audio of the second voice-enabled advertisement is to be customized. Audio is generated from the text of the second voice-enabled advertisement, and because the voice is not to be customized, a standard voice comprises the audio. The standard voice is a voice that does not change from one standard-voice advertisement to another standard-voice advertisement, and is the default voice if voice customization is not desired by the advertiser. The set of advertisements is communicated for presentation to the user, such that the set includes the text and audio that comprises the standard voice, both being associated with the second voice-enabled advertisement.

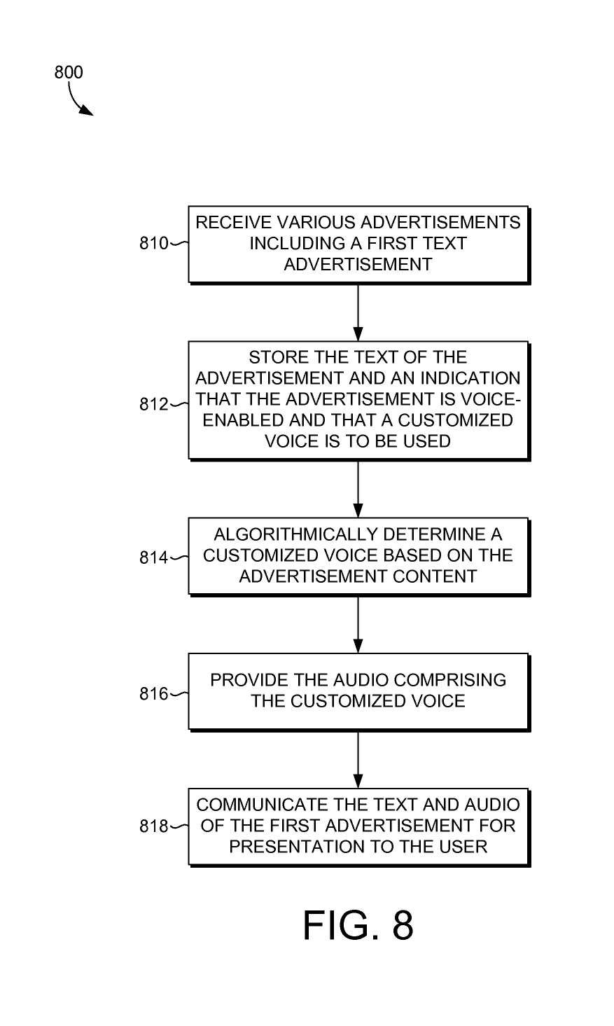

Turning to FIG. 8, a flow diagram is shown illustrating a method 800 for customizing a voice associated with audio of an advertisement based on content of the advertisement, in accordance with an embodiment of the present invention. At step 810, various advertisements are received, including a first text advertisement, which, in one embodiment, comprises only text associated therewith. In one instance, the first advertisement is voice-enabled such that the text is converted to audio prior to being presented to the user. At step 812, the text of the first advertisement and an indication that the first advertisement is voice-enabled are stored in an advertisement storage. As the advertisement is voice-enabled, audio corresponding to the text of the first advertisement is generated prior to presentation of the first advertisement to a user. Also stored here may be an indication that a voice associated with the audio of the first advertisement is to be customized based on content of the first advertisement. The indications, in one embodiment, may be stored in the form of a metadata flag. A customized voice is algorithmically determined at step 814 based on content of the advertisement. As mentioned above, the content may be determined by extracting key words (e.g., by way of data mining) from the text of the advertisement, and associating the key words with predetermined categories having one or more corresponding customized voices. For instance, audio of an advertisement for a manicurist may comprise a customized female's voice, but audio of an advertisement for a car dealership may comprise a customized male's voice.

At step 816, the audio comprising the customized voice is provided. In one embodiment, providing the audio includes generating the audio from the text of the first advertisement, but in another embodiment, providing the audio includes retrieving the audio from the advertisement storage, such that the audio has been previously generated after an earlier request for the advertisement. As mentioned above, audio may be generated at any time between the receipt of the text advertisement and presenting the advertisement to the user. Upon receiving a request for advertisements, the text and audio of the first advertisement are communicated for presentation to the user, illustrated at step 818. The audio comprises the customized voice.

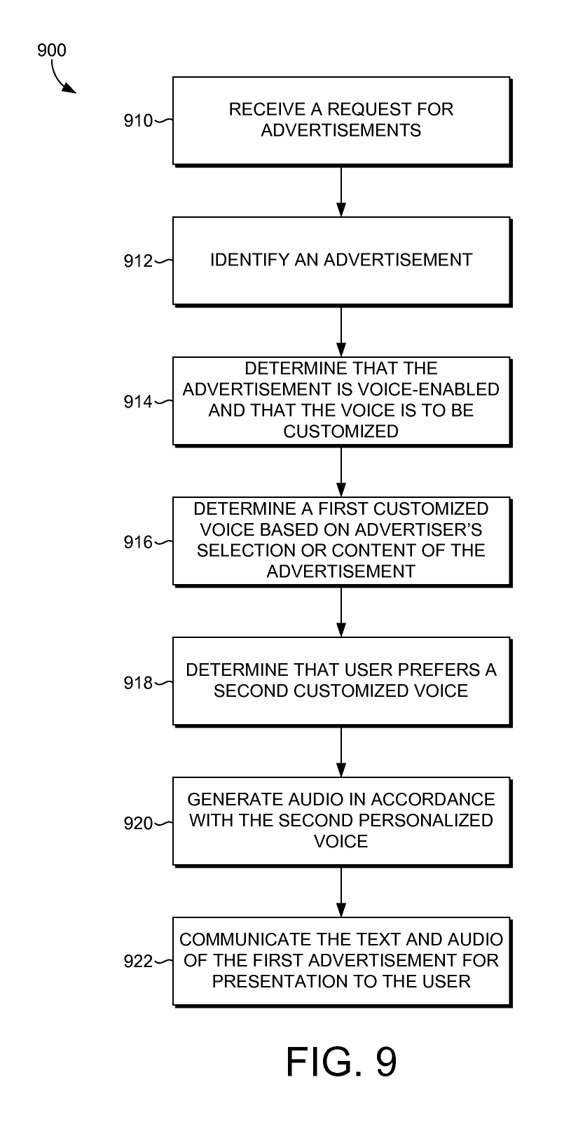

FIG. 9 is a flow diagram showing a method 900 for customizing a voice associated with audio of an advertisement based on user preferences, in accordance with an embodiment of the present invention. Initially, a request is received for advertisements to present to a user at step 910. Advertisements may be presented within web pages, search engine search results, online video games, advertisement-based software applications, and email messages, to name a few. A wide variety of additional approaches and environments exist for delivering online advertising for presentation to users. At step 912, at least a first advertisement is identified to present to the user. It is determined at step 914 that the advertisement is voice-enabled and that a voice audio of the first advertisement is to be customized. In one embodiment, both text and audio of the first advertisement are presented to the user. This determination may be made by an indication on an advertiser UI, such as a selection box that allows an advertiser to select whether an advertisement is voice-enabled, and whether the voice of the audio is to be customized.

At step 916, a first customized voice is determined based on either an indication received from an advertiser that submitted the first advertisement, or based on an algorithmical determination of the first customized voice, which itself is based on content of the first advertisement. A user profile or user preferences associated with the user to whom the advertisements will be presented may be accessed to determine whether the user has a preference for a particular voice in association with advertisements or otherwise. At step 918, it is determined that the user prefers a second customized voice. In one embodiment, anytime that a user has indicated a preference for a particular customized voice, such as a second customized voice, that second customized voice will override any determined customized voices by either the advertiser or an algorithmically determined customized voice. In yet other embodiments, a customized voice is not specified by the user in the user profile, but the customized voice is determined based on other types of information in the user profile. This determination may be made by the advertisement delivery system, for example, and in particular, the customized voice determination component 314 discussed herein in relation to FIG. 3. For instance, a user who is a male and who has indicated interests including cars and football may be more inclined to react to an advertisement if the voice is a male voice. Other types of information included in a user profile may also be taken into consideration when determining the customized voice. In one instance, this determined customized voice based on information in the user profile overrides any other determined customized voice.

But, in another instance, it does not override other customized voices. It may be the case in some embodiments that the advertiser prefers that the user information be the only factors on which the determination of the customized voice is based. As such, this customized voice determined by information in the user profile does not necessarily override other customized voices, but is used as the preferred customized voice for advertisements audibly presented to a certain user. In one case, the selection of the customized voice is based on both user information and content associated with the advertisement. In the embodiment of FIG. 9, the user's selection of the customized voice does override any previous determined customized voice. As such, at step 920, audio is generated for the first advertisement in accordance with the second customized voice. At step 922, the text and audio of the first advertisement are communication for presentation to the user. In one instance, advertisements are presented on a search results page displayed to the user in response to a user-submitted search query.

Turning to FIG. 10, a flow diagram is provided that illustrates a method 1000 for selecting a voice-enabled text advertisement in accordance with an embodiment of the present invention. Initially, a request for advertisements is received at block 1002. The request for advertisements may be received from a variety of different applications in which electronic advertisements may be delivered (e.g., search, web page, video games, etc.). For instance, in one embodiment, a request for advertisements is received from a search engine providing a search results page in response to a search query. In response to receiving the request for the advertisement, a monetization value for each of one or more voice-enabled text advertisement is determined at block 1004. The monetization value is based on a plurality of monetization factors. The plurality of monetization factors may include a CPV value that represents a monetary amount bid by an advertiser for voice audio of the one or more voice-enabled text advertisements.

In embodiments, the plurality of monetization factors may also include any combination of the following: a CTR for advertisements having voice audio but without voice audio activation, a CTR for advertisements having voice audio activation and a maximum completion level, a CTR for an advertisement having voice audio activation and less than a maximum completion level, a CTR for advertisements without voice audio, a CPV for an advertisement having voice audio and a maximum completion level, a CPV for an advertisement having voice audio and less than a maximum completion level, a CPI, a CPC for an advertisement without voice audio, a voice-CPC for an advertisement with voice audio but without voice audio activation, a voice-CPC for an advertisement with voice audio activation and a maximum completion level, and a voice-CPC for an advertisement with voice audio activation and less than a maximum completion level.

Based on the monetization value of each of the one or more voice-enabled text advertisements, one of the one or more voice-enabled text advertisements is selected at block 1006 for presentation. The selection of the one or more voice-enabled text advertisements may be based on a ranking value associated with the advertisements. The ranking value may be based on the monetization value and, thus, an advertisement with a high monetization value may be associated with a high ranking value. At block 1008, the selected voice-enabled text advertisement is communicated for presentation. In embodiments, a plurality of advertisements, including voice-enabled text advertisements and text advertisements, are communicated for presentation.

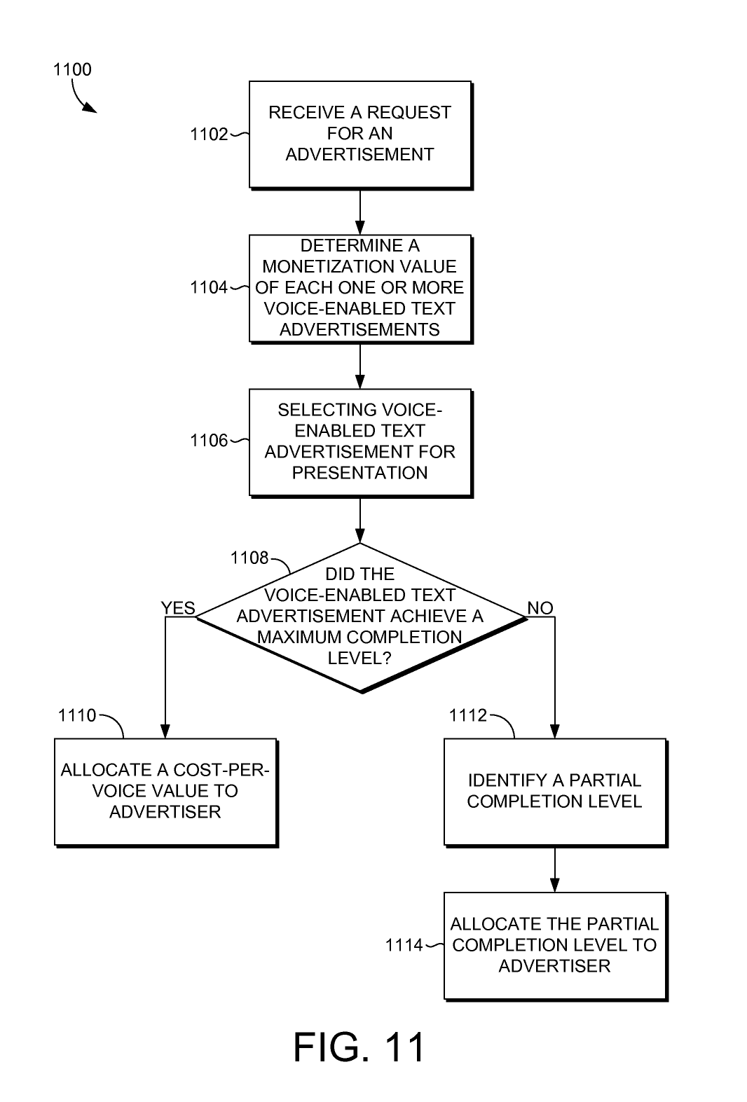

Turning to FIG. 11, a flow diagram is provided that illustrates a method 1100 for allocating a cost for a voice-enabled text advertisement to an advertiser in accordance with an embodiment of the present invention. Initially, at block 1102, a request for an advertisement is received. In response to receiving the request, a monetization value for each of one or more voice-enabled text advertisements is determined at block 1104 based on a plurality of monetization factors and a voice-enabled text advertisement is selected for presentation at block 1106. In embodiments, the plurality of monetization factors includes a CPV value representing a monetary amount bid by an advertiser based on a completion level of voice audio of a voice-enabled text advertisement of the one or more voice-enabled text advertisements. A completion level of voice audio is an indicator of how much voice audio has completed based on an actual display time and a predetermined completion time. An actual display time, which is an amount of time the voice-enabled text advertisement was displayed or the an amount of time the voice audio was presented, may be identified and compared to a predetermined completion time. A predetermined completion time represents an amount of time that an advertisement must be displayed or voice audio must be presented in order to achieve a maximum completion level. An advertisement achieves a maximum completion level when the actual display time is greater than or equal to the predetermined completion time. When the actual display time is less than the predetermined completion time, the advertisement has not achieved a maximum completion level.

A determination of whether the voice-enabled text advertisement achieved a maximum completion level is determined at block 1108. Based upon a determination that the first voice-enabled text advertisement achieved the maximum completion level, the CPV value is allocated to the advertiser at block 1110. Based upon a determination that the first voice-enabled text advertisement did not achieve the maximum completion level, a partial completion level is identified at block 1112. Based on the partial completion level achieved, a partial CPV value is identified and allocated to the advertiser at block 1114. The partial CPV value may be a pro-rated value of the CPV bid based on the completion level achieved by the advertisement. For example, if an advertisement achieves a completion level of 50%, the partial CPV value may be 50% of the CPV bid submitted by the advertiser.

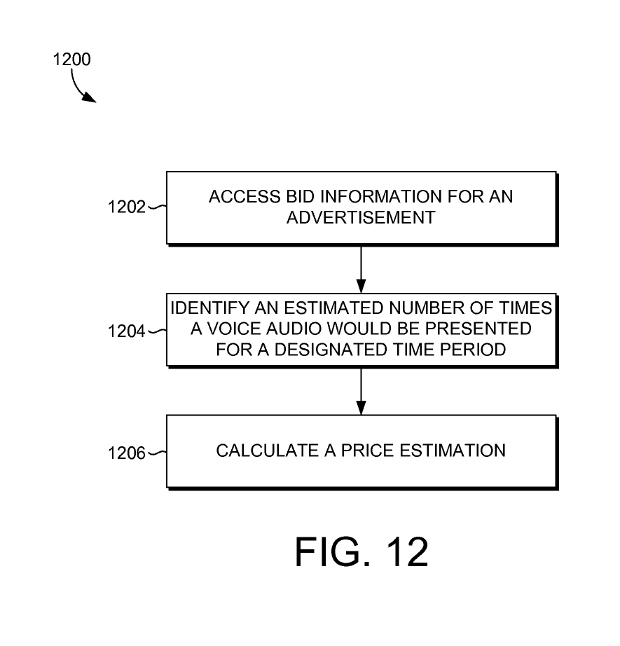

Turning to FIG. 12, a flow diagram is provided that illustrates a method 1200 for calculating a price estimation in accordance with an embodiment of the present invention. In particular, a price estimation corresponds to an estimate of advertising costs for a future time period for an advertiser. For instance, based on past advertising performance information, bid information, and/or other factors, an advertiser's costs for the next month may be estimated and provided to the advertiser. The advertiser may use the information to adjust its advertising campaign (e.g., removing advertisements, adjusting bids, etc.). Initially, at block 1202, bid information for an advertisement is accessed. Bid information may be relevant to a text advertisement or a voice-enabled text advertisement and may include a CPV bid, a CPC bid, or the like. A position associated with the advertisement may also be identified along with a monetization value for the advertisement. The position associated with the advertisement may be a prominent position, a secondary position, or the like. Based on the position associated with the advertisement, a CTR of the advertisement may be adjusted to identify an adjusted CTR. An estimated number of times a voice audio of a voice-enabled text advertisement would be presented for a designated time period is identified at block 1204. Based on the estimated number of times voice audio for the voice-enabled text advertisement is estimated to be presented, a price estimation is calculated at block 1206 The price estimation represents an estimated amount the voice-enabled text advertisement will cost an advertiser for the designated time period. The estimated amount may be calculated for a weekly estimate, a monthly estimate, a yearly estimate, or the like.

As can be understood, embodiments of the present invention provide voice-enabled text advertisements for delivery within electronic advertising environments. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions, that when used by one or more computing devices, cause the one or more computing devices to perform a method comprising:
receiving text of a first voice-enabled advertisement from an advertiser such that audio of a voice is generated from the text of the first voice-enabled advertisement prior to presentation to a user;
receiving an indication that the audio of the first voice-enabled advertisement is to be customized according to a customized voice selected by the advertiser;
generating the audio from the text of the first voice-enabled advertisement, wherein the audio comprises the customized voice;
storing the text of the first voice-enabled advertisement, the indication that the audio is to be customized, and the audio comprising the customized voice in an advertisement storage that contains a plurality of advertisements and related data;
receiving a request for one or more advertisements; and
communicating a set of advertisements from the plurality of advertisements for presentation to the user, wherein the set of advertisements comprises the text of the first voice-enabled advertisement and the generated audio comprising the customized voice.

2. The one or more computer storage media of claim 1, further comprising retrieving the text of the first voice-enabled advertisement and the audio comprising the customized voice from the advertisement storage.

3. The one or more computer storage media of claim 2, wherein the audio is generated immediately subsequent to receipt of the first voice-enabled advertisement.

4. The one or more computer storage media of claim 2, wherein the audio is generated prior to a first instance that the first voice-enabled advertisement is requested for presentation to a particular user.

5. The one or more computer storage media of claim 2, wherein the audio is generated subsequent to receiving the request for the one or more advertisements.

6. The one or more computer storage media of claim 1, wherein the customized voice comprises one or more of a woman's voice, a man's voice, a child's voice, a senior citizen's voice, a robot-sounding voice, or an alien-sounding voice.

7. The one or more computer storage media of claim 1, further comprising:
receiving the text of a second voice-enabled advertisement;
receiving the indication that the voice associated with the audio of the second voice-enabled advertisement is to be customized; and
generating the audio of the second voice-enabled advertisement.

8. The one or more computer storage media of claim 1, further comprising:
receiving the text of a second voice-enabled advertisement;
determining that an indication has not been received that the voice associated with the audio of the second voice-enabled advertisement is to be customized;
generating the audio from the text of the second voice-enabled advertisement, wherein the audio comprises a standard voice; and
communicating the set of advertisements for presentation to the user, wherein the set of advertisements comprises the text of the second voice-enabled advertisement and the audio comprising the standard voice.

9. The one or more computer storage media of claim 1, further comprising storing one or more metadata flags indicating that the first voice-enabled advertisement is voice-enabled, and that the audio of the first voice-enabled advertisement comprises a customized voice.

10. The one or more computer storage media of claim 1, wherein the first voice-enabled advertisement comprises only text.

11. One or more computer storage media storing computer-useable instructions, that when used by one or more computing devices, cause the one or more computing devices to perform a method comprising:
receiving from various advertisers a plurality of advertisements including text of a first advertisement that is voice-enabled, wherein voice of the first advertisement is to be customized;
in association with the first advertisement, storing in an advertisement storage,
(1) text of the first advertisement,
(2) an indication that the first advertisement is voice-enabled such that audio corresponding to the text of the first advertisement is generated prior to presentation of the first advertisement to a user, and
(3) an indication that a voice associated with the audio of the first advertisement is to be customized based on content of the first advertisement;
in response to the indications that the first advertisement is voice-enabled and that the voice associated with the audio is to be customized, algorithmically determining a customized voice for the audio of the first advertisement, wherein the determination of the customized voice is based on the content of the first advertisement;
providing the audio generated from the text of the first advertisement based on the determined customized voice; and
upon receiving a request for one or more advertisements, communicating a set of advertisements for presentation to the user, wherein the set of advertisements includes the text of the first advertisement and the audio comprising the customized voice.

12. The one or more computer storage media of claim 2.1, wherein providing the audio further comprises generating the audio from the text of the first advertisement.

13. The one or more computer storage media of claim 2.1, wherein providing the audio further comprises retrieving the audio from the advertisement storage, wherein the audio has been previously generated after a prior request for the first advertisement.

14. The one or more computer storage media of claim 2.1, further comprising performing data mining on the first advertisement to extract one or more key words.

15. The one or more computer storage media of claim 9, further comprising determining a category associated with the first advertisement based on the key words.

16. The one or more computer storage media of claim 10, wherein the first customized voice is determined based on the determined category.

17. The one or more computer storage media of claim 7, further comprising storing in an advertisement storage the generated audio.

18. The one or more computer storage media of claim 2.1, wherein the content of the first advertisement comprises one or more key words extracted from the text of the first advertisement.

19. One or more computer storage media storing computer-useable instructions, that when used by one or more computing devices, cause the one or more computing devices to perform a method comprising:
receiving a request for one or more advertisements for presentation to a user;
identifying at least a first advertisement to present to the user,
determining that the first advertisement is voice-enabled and that a voice associated with audio of the first advertisement is to be customized, wherein both the text and the audio of a voice-enabled advertisement are presented to a user;
determining a first customized voice associated with the first advertisement, wherein the determining is based on one or more of,
(1) an indication of the first customized voice received from an advertiser associated with the first advertisement, or
(2) an algorithmical determination of the first customized voice based on content of the first advertisement;
accessing user preferences associated with the user to determine that the user has indicated a preference for a second customized voice for the first advertisement;
generating the audio from the text of the first advertisement, wherein the audio comprises the second customized voice; and
communicating the text of the first advertisement and the audio comprising the second customized voice for presentation to the user.

20. The one or more computer storage media of claim 19, wherein the request for the one or more advertisements is for presentation of the one or more advertisements on a search results page displayed to the user in response to a user-submitted search query.
